(19) United States
(12) Patent Application Publication
(10) Pub. No.: US 2016/0281427 A1
(43) Pub. Date: Sep. 29, 2016

(54) LADDER STABILISER AND STABILISED LADDER

(71) Applicant: ROJAK DESIGN LTD, York (GB)

(72) Inventor: Barrie Weatherall, York (GB)

(21) Appl. No.: 14/778,387

(22) PCT Filed: Mar. 19, 2014
(86) PCT No.: PCT/EP2014/000748

§ 371 Date: Sep. 18, 2015

(30) Foreign Application Priority Data
Mar. 19, 2013 (GB) 1305022.4
May 8, 2013 (GB) 1308225.0

(51) Int. Cl. E06C 7/46; E06C 7/44; E06C 7/42

(52) U.S. Cl. CPC E06C 7/46; E06C 7/42; E06C 7/44

(57) ABSTRACT

A ladder stabiliser for use with a ladder comprising two stiles positioned against a wall, the ladder stabiliser comprising a body, a securing mechanism for releasably securing the body to the ladder and two or more feet for engagement with a surface wherein the securing mechanism and feet are configured such that in use the feet are located on the surface at points which are distant from the point at which the axes of the stiles intersect the surface. A line between the feet of the stabiliser and the top of the ladder stiles is at an angle of about 55 to 65° to the ground and the ladder is at an angle of 70 to 80° to the ground.

The invention relates to a ladder stabiliser and to a stabilised ladder. The ladder stabiliser is suitable for use with a ladder to provide improved safety during use of a ladder by reducing the risk of ladder failure and enabling the ladder to be used more safely. The stabilised ladder similarly provides improved safety as compared to a conventional ladder.

Ladders have been used for thousands of years and the basic design of a ladder has not changed radically in that time. Ladders generally comprise three elements; stiles (legs) rungs and feet. However, ladders notoriously give rise to many accidents including fatalities there being tens of thousands of ladder accidents every year in the UK and, according to industry estimates over 500,000 ladder accidents each year in Europe.

The difficulties and dangers inherent in the use of ladders has been recognised and received attention for many years. Ladder, “failure”, that is where a ladder collapses while in use, may arise due to a number of reasons including sideways slip of the upper end of a ladder and slippage of the foot of a ladder away from the structure against which it is being used, referred to herein as “outward slip”.

Ladders are used in a wide range of applications both domestically and commercially and in many different environments as regards the ground upon which the base of the ladder is placed and the wall against which the top of the ladder rests. The ground may for example be uneven or inclined, slippery or loose for example due to ice, gravel, grass, moss, building site debris and the like, all of which may present a hazard unless due care is taken by the user. The wall against which the ladder rests may also present hazards. For example, the wall may be uneven, not precisely vertical or there may be obstructions such as windows and drain pipes, gutters and the like. In addition, as a practical matter, the user may lean laterally of the ladder and thereby impart greater force to one side or the other of the ladder and cause the top of the ladder to move. This is particularly dangerous as once the ladder becomes unstable together with the weight of the user exacerbating the instability, serious accidents may occur. Where a ladder is used towards the end of a wall, lateral slippage may cause the ladder to move beyond the end of the wall and lose support altogether with potentially major consequences.

Many devices have been proposed for imparting improved stability to a ladder at the upper end of the ladder, for example stand-offs, and the lower end, for example attachments to the feet of the ladder or plate-like devices having upstanding parts to provide a physical abutment for the feet of the ladder whilst the weight of the ladder and user urges the plate into the ground to reduce the risk of outward slip, for example as described in GB-A-2216168. Also ladders having wide base bars with feet are also known but these essentially move the ladder feet to the side of the ladder and although this helps in reducing some sideways movement his has minimal benefit in reducing outward slip.

Outward slip arises due to the weight of the user and ladder presenting a force having a significant resolvable horizontal component, referred to as a slip force, which exceeds the frictional force between the ladder feet and the ground. Outward slip remains a significant problem due to a wide range of surfaces upon which a ladder might be used, the wide range of applications and also due to user error or lack of care.

For many years, guidelines have recommended that ladders be used at angle at of 75° to the ground. This angle is a compromise allowing the ladder to be as near vertical as possible to reduce the risk of outward slip whilst allowing the weight of the ladder and user to impart a force through the top of the ladder into the wall or other structure against which the ladder is being used to reduce the risk of sideways slip at the top of the ladder. Also, many leaning ladders are now designed to be used at a leaning angle of 75° to the ground and the tops of the rungs are designed to be level at this angle to improve stability and encourage correct usage.

A ladder is generally stable until a user climbs on ladder at which point, the motion of the user and their weight distribution places the ladder in a dynamic environment. In particular, as the user climbs and descends a ladder the user movement may cause the ladder to rise and fall slightly. This can lead to the ladder gradually creeping outwards with increasing risk of outward slip until it reaches a failure point and collapses catastrophically. The up and down movement of the ladder arises due to flexing of the stiles or bouncing of the stiles on the ground. Ladders are made of a wide range of materials and different qualities of construction such that the level of flex may vary widely from ladder to ladder. Safe usage however is a universal requirement for all ladders.

The up and down movement also may give rise to undesirable movement or resonance at the top of the ladder and wheels have been fitted, at the top of ladders to dissipate this energy. Movement or resonance at the top of the ladder may be reduced by reducing the angle of the ladder but this increases the risk of outward slip.

Ladders must also comply with legislation regarding working at height in certain countries, for example Work At Height Regulations (WAHR) in the UK, based on a European Directive 2001/45/EC and employers may have a duty of care to employees to ensure equipment used in the course of employment is safe and meets all appropriate regulations.

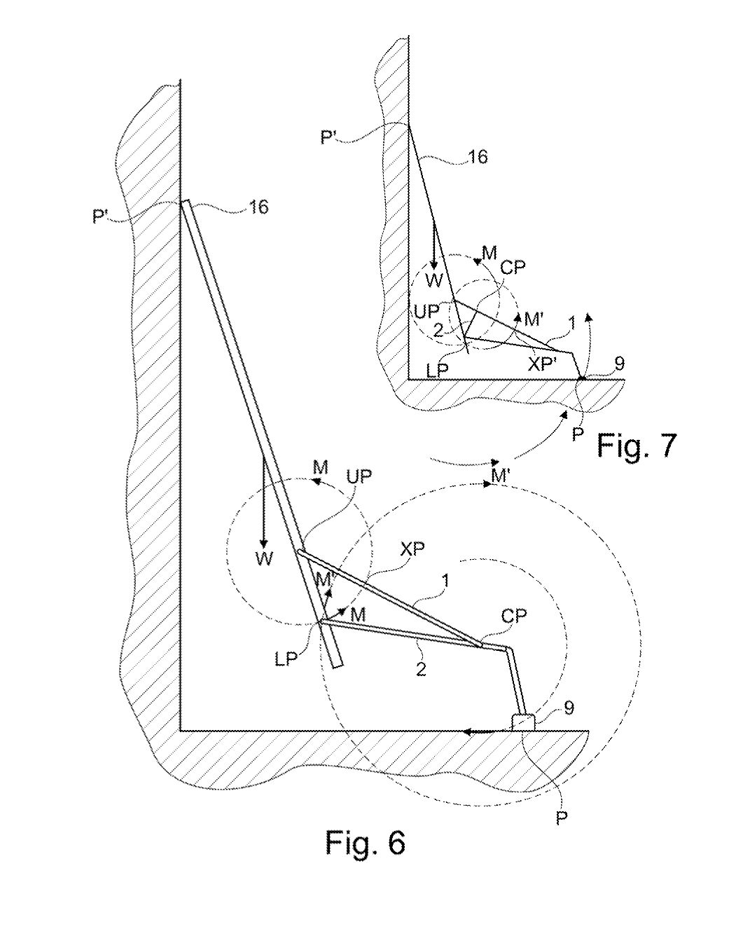

US2009/0107765 describes an extension ladder stabiliser having a pair of elongate ladder mount members, a pair of elongate stabiliser legs swivelly mounted on the mount members, a pair of leg braces having a pair of leg receptacles carried by the ladder mount members. FIG. 6 shows an extension ladder stabiliser in which the mount members are obtuse to the stabiliser legs and the stabilising legs are pivoted and rotated relative to the rest of the stabiliser into a working configuration. The leg braces are oriented in a generally perpendicular direction to the axis of the stabiliser legs and are also pivoted into the required position for engagement with the stabilising. The leg braces are then connected to the stabilising legs employing, for example, a leg clasping mechanism.

In use, the weight of a user on the ladder may apply significant force to the pivot points of the ladder stabiliser described in US2009/0107765 and may lead to weakness or failure. Further, assembly of the stabiliser into its working configuration may be inconvenient or complicated as it requires relative movement and connection of several parts of the stabiliser. Whilst stability of the ladder is said to be improved against lateral movement at the top of the ladder and also against the risk of the ladder falling backwards, that is the top of the ladder coming away from the supporting wall, as the user grasps the ladder, there is no indication of improved stability at the point of contact with the ground against outward slip.

However, we have now found that the problem of outward slip and also improving ladder stability at the top of the ladder by reducing movement without increasing the risk of outward slip may be ameliorated by providing a stabilised ladder or a ladder stabiliser which suspends the ladder off the ground and has supporting feet located such that in use they engage the ground at a point more distant from the wall than where the feet of the ladder would engage without the use of the stabiliser and is configured such that the weight of the user avoids urging the feet of the stabiliser or stabilised ladder in a direction away from the wall.

The invention provides in a first aspect a ladder stabiliser for use with a ladder comprising two stiles positioned against a wall, the ladder stabiliser comprising a body, a securing mechanism for releasably securing the body, to the ladder and two or more feet for engagement with a surface wherein the securing mechanism and feet are configured such that in use the feet are located on the surface at points which are distant from the point at which the axes of the stiles intersect the surface. In a second aspect the invention provides a ladder stabiliser for use with a ladder comprising two stiles positioned against a wall, the ladder stabiliser comprising a body, a securing mechanism for releasably securing the body to the ladder and two or more feet for engagement with a surface wherein the feet are configured such that in use a line between the feet and the top of the ladder stiles is at an angle of about 55 to 65° to the ground and the ladder is at an angle of 70 to 80° to the ground.

In a third aspect the invention provides a stabilised ladder comprising a ladder portion and a ladder stabiliser assembly integral with the ladder portion, the ladder portion comprising two stiles connected by a plurality of rungs generally perpendicular to the stiles and being suitable for positioning against a wall in use, the ladder stabiliser assembly comprising a body portion integrally connected to the ladder portion and two or more feet for engagement with a surface wherein the body and feet are configured such that in use the feet are located on the surface at points which are distant from the point at which the axes of the stiles intersect the surface.

In a fourth aspect the invention provides a stabilised ladder comprising a ladder portion and a ladder stabiliser assembly integral with the ladder portion, the ladder portion comprising two stiles connected by a plurality of rungs generally perpendicular to the stiles and being suitable for positioning against a wall in use, the ladder stabiliser assembly comprising a body portion integrally connected to the ladder portion and two or more feet for engagement with a surface wherein the body and feet are configured such that in use a line between the feet and the top of the ladder stiles is at an angle of about 55 to 65° to the ground and the ladder portion is at an angle of 70 to 80° to the ground.

The term “integral” as employed herein means the stabiliser assembly and ladder portion may be different elements of a single part and may be formed in a single process or be fixedly connected, for example welded together. The term also includes the case where the stabiliser assembly and the ladder portion interlock or inter-engage in some way, for example by means of connectors such as male and female connectors and are not releasable from each other for example in the manner of interlocking rings, and are not necessarily different elements of a unitary part.

The term “ladder portion” refers to that part of the stabilised ladder comprising two stiles connected by rungs which is climbable by the user.

Suitably, the securing mechanism and feet are configured such that in use the feet transmit load from the ladder in a generally vertical direction to the surface.

The invention further provides a stabilised “floating” ladder comprising a ladder stabiliser according to the invention wherein the stabiliser supports the ladder at an angle of 70 to 80° to the ground and the angle between a line through the feet of the stabiliser and the top of the ladder stiles to the ground is 55 to 65°.

We have also surprisingly found that to a user, a ladder mounted with a stabiliser of the invention has a robust feel and is much more difficult to move away from a wall than a comparable ladder standing on the ground. This enhanced “feel” is beneficial to the user and provides a basis for confidence in the safe usage of the ladder.

By “floating” we mean a ladder which in use is not in direct contact with the supporting ground and wherein the force due to the weight of the ladder and the user is reacted against the supporting ground at a location distant from the point at which the longitudinal axes of the ladder stiles intersect with the supporting ground.

The stabiliser may be located at the bottom and/or the top of the ladder. When the stabiliser is located at the top of the ladder, the bottom of the ladder may be on the ground or may itself be suspended by a further ladder stabiliser, preferably according to the invention.

By suspending the ladder above the ground with the stabiliser feet distant from the point of intersection of the axes of the ladder stiles with the ground, provides a “damper” effect such that changes in force due to movement of the user may be absorbed to a degree thereby reducing the slight up and down motion of the ladder and reducing the risk of outward slip. As compared to employing a ladder in a conventional way, the stabiliser enables a greater normal force to pass from the stabiliser to the ground and a lower slip force, thereby reducing the dependency on friction to keep the ladder in position. The invention is particularly suitable for use where higher risks of outward slip may arise due to the reduced reliance on friction between the ladder and surface to avoid outward slip.

Advantageously, the stabiliser is constructed and configured such that it may be used with any design of ladder. This allows ladders of different materials of construction, lengths and qualities to be stabilised by use of the stabiliser, whether ladders for professional use or private or domestic use, and whether indoors or outside. The stabilised ladder may also be constructed of any suitable material.

The stabiliser is suitable for use with a ladder having hollow rungs such that the stabiliser may be engaged with the ladder through the internal surface of the rungs thereby reducing intrusion and potential obstacle for the user. Also, if the physical construction of a ladder is altered including drilling holes in it to fit an accessory, standards associated With British and European legislation or standards guidelines may be compromised. By engaging with hollow rungs, the stabiliser does not require the integrity of the ladder to be compromised. The stabiliser in a preferred embodiment engages with the outside of the rungs of the ladder, for example by means of one or more channels into each of which a rung may be located or by a plurality of retaining lugs for each rung, the lugs suitably having a channel-shaped cross section into which a rung may be located.

For a stabilised ladder according to the invention, the stabiliser assembly is integral with the ladder portion and may be connected to any part of the ladder portion. In one embodiment, a rung of the ladder portion also forms part of the body portion of the stabiliser assembly. This arrangement in which the rung forms a part of the ladder portion and a part of the body portion of the stabiliser assembly is ergonomically advantageous and minimizes potential obstacles for the user. In another embodiment, the ladder portion comprises a hollow rung and the body portion comprises a part which passes through the hollow rung such that the stabiliser assembly and the ladder portion are interlocked.

Where the physical construction of a ladder is altered including drilling holds in it to fit an accessory, standards associated with British and European legislation or standards guidelines may be compromised. By providing an integral ladder portion and stabiliser assembly, the stabilised stabiliser does not require the integrity of the ladder to be corn promised

Suitably the body of the ladder stabiliser comprises a frame having an upper part for engagement with a first rung of a ladder and a lower part for engagement with a lower rung of a ladder. The upper and lower parts are suitably engagable with rungs which are spaced apart, for example two rungs apart, preferably the bottom rung and the third rung up from the bottom of the ladder.

The upper part and lower part are connected at a point distant from the ladder. The distance from the point at which the upper part engages the ladder to the point at which the lower part and upper part are connected is greater than or equal to the distance from the point at which the lower part engages the ladder to the point at which the lower part and upper part are connected. This is in clear contrast to the arrangement shown in US2009/0107765 and provides surprising technical advantage in reducing or avoiding the risk of outward slip. This configuration suitably allows the weight of the user to act such that it avoids urging the feet of the stabiliser or stabilised ladder in a direction away from the wall and preferably urges the feet towards the wall.

Without wishing to be bound by theory, it is believed that where the centre of gravity of the user is closer to the wall than the point at which the upper part engages the ladder (herein referred to as UP), a moment is created about the point UP which pivots from the line of the weight of the user, under the point UP and this urges the point at which the lower part engages the ladder (herein referred to as LP) away from the wall but in a direction about the point at which the lower part and upper part are connected (herein referred to as CP). Taking the point CP as a pivoting point, the point LP pivots about CP in the opposite sense to that in which the point LP pivots about the point UP. This is because the distance UP to CP is greater than the distance UP to LP. The point where the stabiliser or stabilised ladder contacts the ground is accordingly urged towards the wall rather than away from it.

The upper part and lower part of the frame may be movable relative to each other at the point at which the upper and lower part are connected. The upper part may be slidably movable relative to the lower part.

In the case of the stabilised ladder, whilst the body portion is integrally connected to the ladder portion, preferably the ladder portion and the stabiliser assembly may be moved relative to each other. Desirably the upper part and the lower part of the frame are movable relative to the ladder portion and relative to each other such that the stabiliser assembly may be adjusted to maintain the ladder portion level, that is without lateral deviation between the top and the bottom of the ladder portion relative to the vertical, while the feet accommodate sloping or uneven ground.

Preferably, the upper part of the frame is connected to the lower part of the frame by a bracket and the bracket comprises a track attached to either the upper or the lower part such that the other part is held within the track and slidably moveable along the track relative to the other part. The body of the stabiliser is preferably made from tubular struts.

Suitably, the stabiliser comprises a rigid body with which two or more rungs of the ladder engage. Securing means for example a ratchet and strap may be employed to secure the rigid stabiliser to the ladder. The rigid body preferably does not comprise any parts which move relative to each other or which are pivotally connected for relative movement for example rotation.

In another embodiment, the stabiliser may comprises two halves, a left half, for engagement with a left stile of a ladder and a right half for engagement with a right stile of a ladder and where the two halves are releasably securable to each other upon engagement with the ladder. The stabiliser in two halves may also be packed economically enabling easy transport and storage.

Preferably, the securing mechanism for releasably securing the stabiliser to the ladder is manually operable without tools. Whilst a mechanism requiring the use of tools may be employed, desirably the said means are manually operable without the use of tools for the convenience of the user.

The stabiliser may be secured to the ladder using any conventional means of attachment provided the stabiliser and ladder are securely fastened to each other and relative movement at the point of joining does not occur. The securing means may comprise a bolt arrangement, for example a “J” bolt which hooks around one or more rungs and may be tightened into fixed relationship with the ladder. Straps or other flexible securing means may be employed as desired.

In a preferred embodiment the securing mechanism comprises a bracing bracket which is adapted to engage the back of the ladder relative to the position of the stabiliser thereby securing the stabiliser and ladder together and optionally said bracing bracket comprising male and female parts interengageable with each other.

Preferably, the upper part of the frame, the lower part of the frame and a bracing bracket all engage the ladder so as to provide a stable engagement enabling transmittal of force to the feet of the stabiliser with minimal relative movement as between the ladder and the stabiliser.

In a preferred embodiment, the stabiliser is suitable for and adapted for use with a ladder having hollow rungs wherein the securing mechanism comprises male and female parts interengageable with each other through a hollow rung of the ladder. Suitably, the securing mechanism comprises two pairs of male and female parts with each male and female pair being interengageable through a hollow rung of the ladder. The rungs are desirably two rungs apart, for example the lowest and third rung from the bottom of the ladder.

Advantageously, the feet offer a large surface area as compared to conventional ladder feet. The feet suitably each comprise a downwardly facing friction surface. The friction surfaces are adapted to contact a generally horizontal surface, for example the ground or a scaffolding level. The weight of the user will act to urge the friction surface onto the generally horizontal surface. The friction surface preferably comprises a stop, desirably made of rubber or a plastics material and optionally have a frictional surface pattern. Preferably, each foot is connected to the body of the stabiliser via a universal joint allowing use on uneven or sloping ground.

Preferably each foot is connected to the body of the stabiliser via a part which may be arranged in a first configuration such that the feet are engagable with the ground and a second configuration whereby the feet are 180° from the first configuration whereby the stabiliser may be employed at the top of a ladder for engaged with a surface at the top of the ladder.

Suitably, the stabiliser supports the ladder at an angle of 70 to 80° to the ground, preferably 75° as per industry standards and recommendations. This also enables safe usage of the ladder.

Preferably the ladder stabiliser or stabilised ladder is constructed of metal, for example aluminium or light steel to provide an optimal combination of ease of production, cost and strength.

In a further aspect, the invention provides a kit of parts for assembly into a stabilised ladder comprising:
i) a stabiliser according to the invention; and
ii) a ladder.

The stabiliser of the invention may also be employed at the top of a ladder where the ladder is used for access to a surface, for example a flat or pitched roof or scaffolding. A stabiliser may be used at both the bottom and top of the ladder or if desired at the top of the ladder alone.

The stabiliser may comprise locating means for receiving and two or more detachable abutments connectable to the body of the stabiliser for example as described in GB-A-2457770. Each abutment may have one contact surface or a first and second contact surface and being connectable to the body to provide one or more configurations for use.

The stabiliser when configured with the detachable abutments may suitably be employed at the top of the ladder to provide stabilisation and may be employed in a variety of ways. For example the abutments may each present a first contact surface for abutting the wall outside the stiles of the ladder such that the distance between the two first contact surfaces is greater than the width of the ladder and wherein the ladder is spaced away from the wall. Suitably, in another configuration the abutments each present a contact surface for abutting adjoining walls at a corner or for engaging a generally horizontal surface.

The invention also provides for a kit of parts for assembly into a ladder stabiliser comprising:
i) a stabiliser according to the invention; and
ii) two or more detachable abutments connectable to the body, each abutment having a contact surface and being connectable to the body to provide one or more configurations for use.

The ladder stabiliser with the detachable abutments provides flexibility of use in allowing the user to select a preferred configuration to provide enhanced stability in a variety of locations for example against a corner of a wall, against a flat roof or to provide a safe and convenient working position through being spaced away from the wall.

The body suitably comprises complementary connecting parts for connection with the at least two abutments in a first configuration and complementary connecting parts for connection with the at least two abutments in a second configuration. Preferably the connecting parts of the abutments and the body are manually connectable, for example a push-fit arrangement, and provide a rigid connection between the abutments and the body. The connection is suitably manually releasable and comprises locking means.

In an especially preferred embodiment the connecting parts comprise a tubular socket having holes spaced along its length and a member which is slideably insertable in the socket and which, for locking means, has a retractable, sprung notch such that on insertion of the member in the tubular socket, the notch may spring through any one of the holes thereby securing the connecting parts together. The parts may be released by manually depressing the notch and removing the member. The body is suitably constructed of tubular material providing hollow ends in which the abutments may be snugly fixed and retained in a first configuration or a second configuration.

The abutment may comprise the socket and the body may comprise the sliding member but preferably, the body comprises two pairs of sockets, a first pair for use in a first configuration and a second pair for use in a second configuration, and the abutments each comprise a slideably insertable member having locking means. Advantageously, construction is simplified by requiring only one pair of locking means on the abutments rather than two pairs on the connecting parts on the body.

The invention also provides in a further aspect a stabilised ladder kit comprising a ladder and a ladder stabiliser according to the present invention. The ladder stabiliser of the invention may also be employed as or formed as an integral part of a ladder. Accordingly, the invention provides a stabilisable ladder comprising a ladder and a ladder stabiliser according to the present invention as described herein.

The invention is illustrated in a non-limiting manner by reference to the accompanying drawings in which:

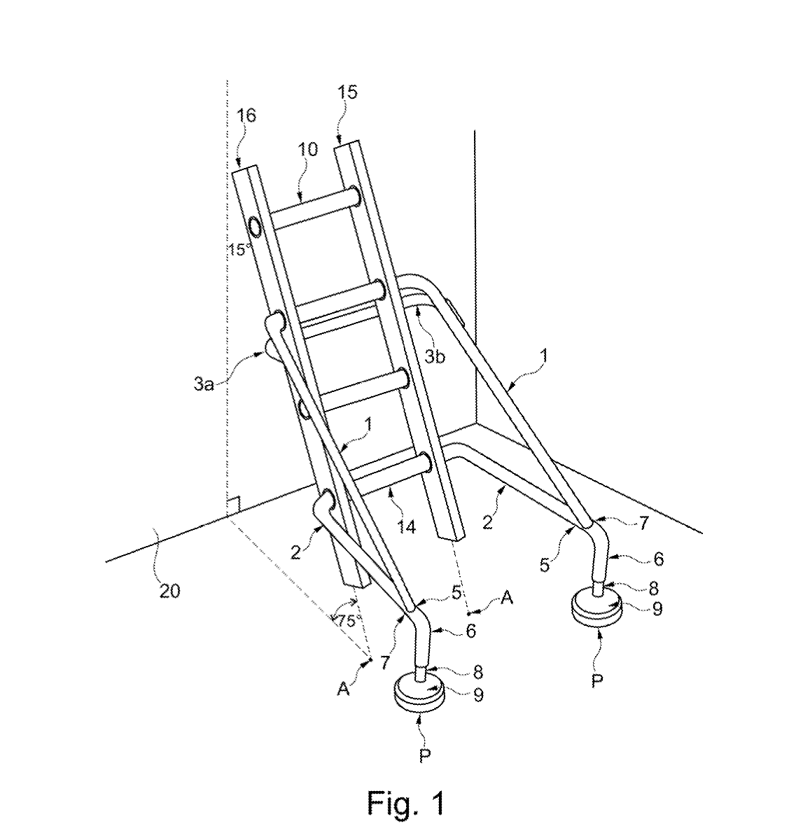

FIG. 1 shows a perspective view of a ladder stabiliser according to the invention attached to a ladder;

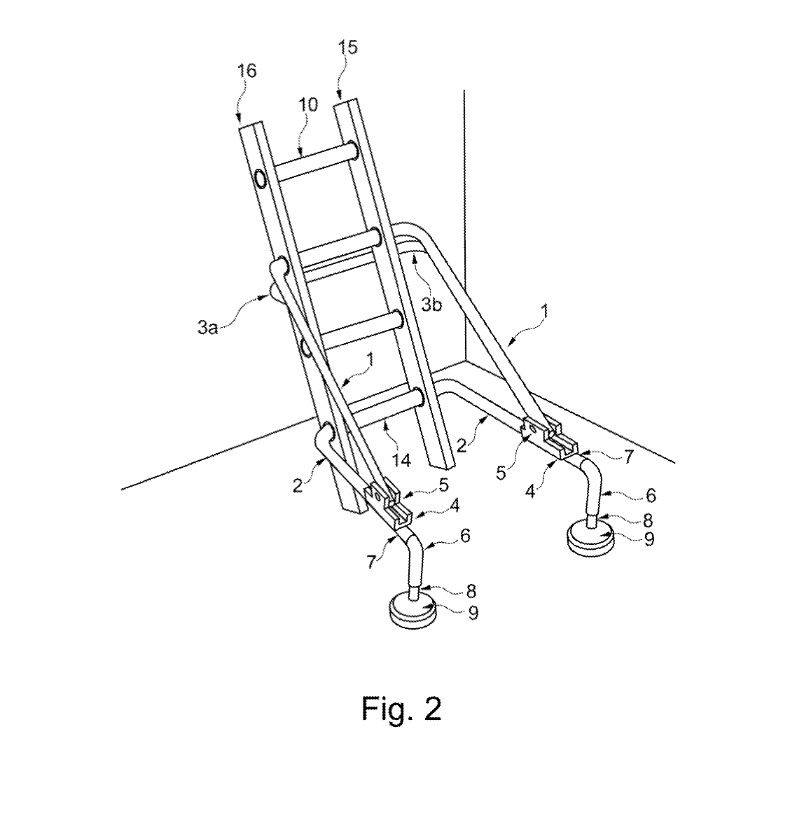

FIG. 2 shows a perspective view of a ladder stabiliser according to the invention attached to a ladder;

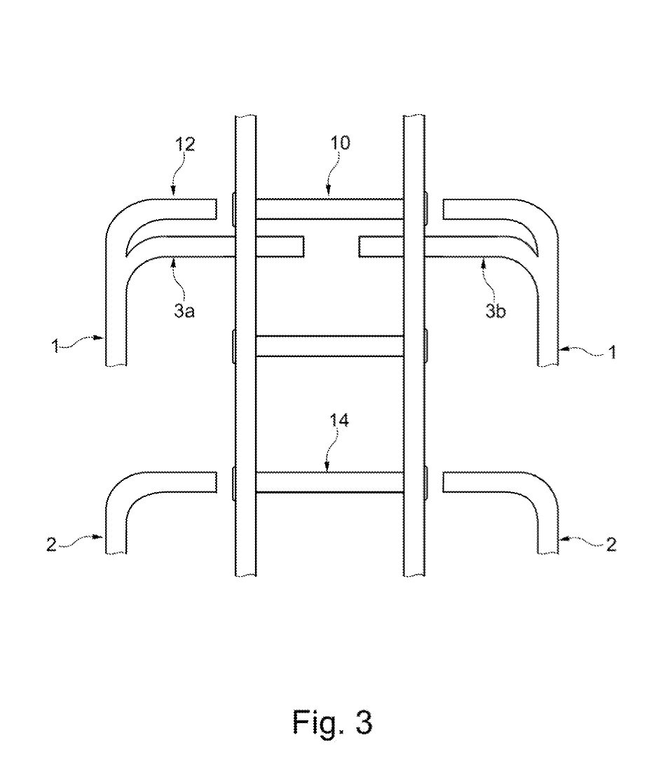

FIG. 3 shows a plan view of part of a ladder stabiliser according to the invention prior to engagement with a ladder having hollow rungs;

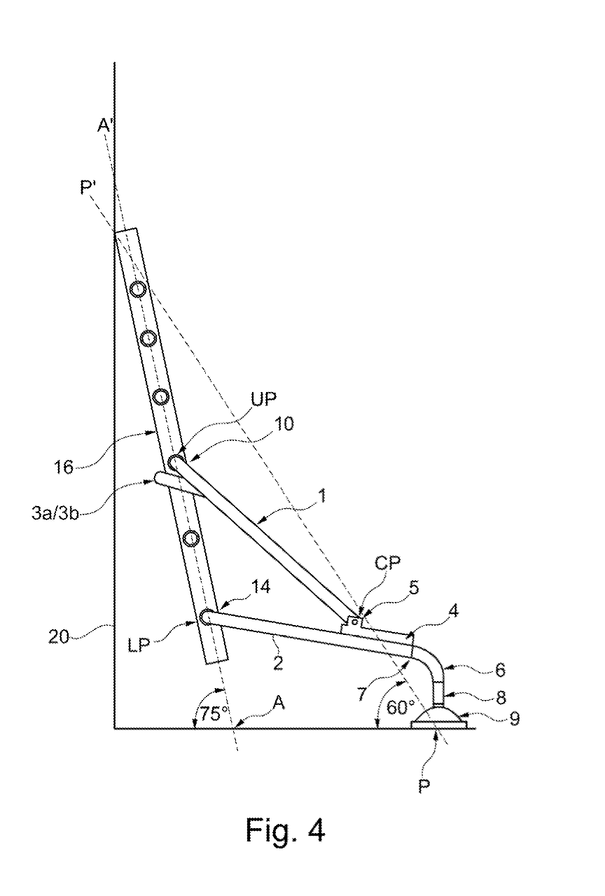

FIG. 4 shows a side view of a ladder stabiliser according to the invention supporting a ladder leaning against a wall;

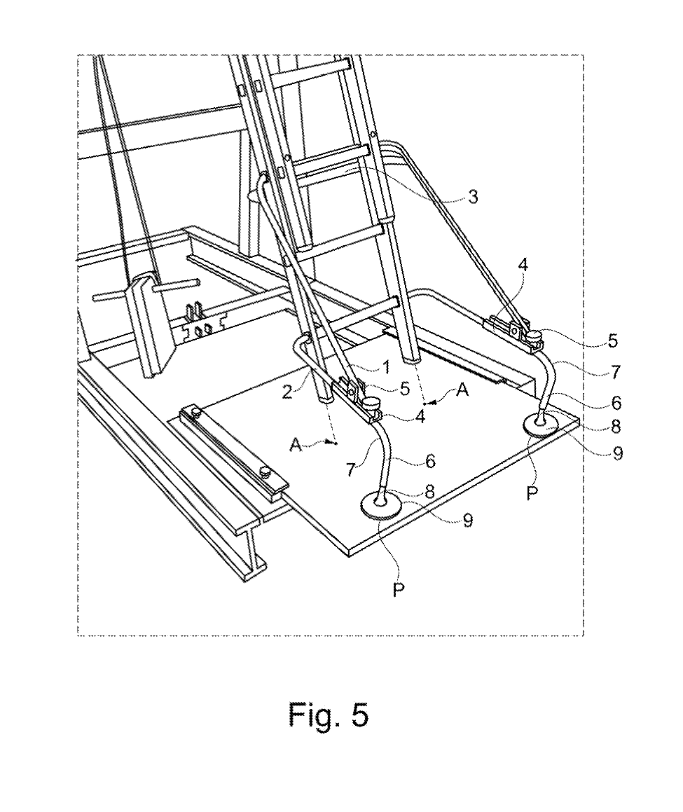

FIG. 5 shows a photograph of a prototype of the ladder stabiliser and a stabilised ladder according to the invention; and

FIG. 6 shows a schematic side view of a ladder stabiliser according to the invention supporting a ladder leaning against a wall.

FIG. 7 shows a schematic side view of a ladder stabiliser which is not according to the invention supporting a ladder leaning against a wall.

In FIG. 1, shaped struts 1 and 2 are joined together at point 5. Both struts 1 are releasably securable to a rung of a ladder and both struts 2 are releasably securable to a lower rung, suitably two rungs below the rung to which the strut 1 is secured. Struts 2 end in part 6 having a foot 9. The struts 1 and 2 are configured such that when assembled, the ladder is suspended above the ground and the struts 1 and 2 transmit load from the ladder through the feet 9 in a generally vertical direction, normal to the ground. The struts 1 and 2 are rigid and may flex to absorb or damp any movement generated by motion of a user on the ladder. The ladder is at about 75° to the ground 15° to the wall 20. The axes of the stiles 15, 16 extend and intersect the ground at points A. The feet 9 are located at points P which are distant from points A. Suitably, a straight line through point P and the top of the stile is at an angle of about 60° to the ground and 30° to the wall 20.

The angle of the ladder accordingly is at the industry recommended angle relative to the wall and reduces the risk of outward slip and the stabiliser by transmitting the load from the ladder vertically also minimises the risk of slip. The angle between the feet 9 and the top of the stiles is such as to minimise movement at the top of the stiles. By suspending the ladder, the stabiliser enables the ladder to be at an actual angle which is different to the effective angle between the top of the stiles and the feet 9 thereby addressing both the problems of outward slip and movement at the top of the stiles. The flexing capability of the stabiliser also ameliorates adverse effects of creep due to movement of the user on the ladder.

In FIG. 2, struts [1 and 2 and joined by bracket 5 which allows the struts, 1 and 2 to be moved relative to each other to a desired position. Bracket 5 is suitably a movable fitting, for example an axle type fitting (not shown here). Suitably the fitting passes through strut 1 and the bracket 5. The bracket 5 sits on a moveable plate (not shown) which is movable along a track 4. Track 4 is fixed, for example welded, to strut 2. Each foot 9 is connected to part 6 by a universal joint 8. The feet 9 are capable of articulation to sit on any surface. Suitably feet 9 offer a larger surface area than a conventional ladder foot and is universally jointed enabling use on sloping ground and providing for maximum contact. Part 7 may be rotated through 180° at point 7 to allow the stabiliser to be fitted to the top of the ladder to gain safe stabilised access to both flat and pitched roofs.

The upper part strut 1, lower part strut 2 and parts 7 are preferably tubular. Both tubes 1 are configured to engage with a rung of the ladder through the hollow space in the rung. Similarly both tubes 2 are configured to engage with the ladder on the interior of a hollow rung. Access to the ladder is afforded without physical obstruction and the construction of the ladder is not modified thereby avoiding risks of non-compliance with standards of construction or use. A bracing bracket made of parts 3a and 3b depends from tubes 1 and engage behind the ladder to provide additional stability and security of engagement.

FIG. 3 shows the stabiliser about to be fitted to the ladder by inserting the end part 12 of tube 1 into the hollow body of an upper rung of the ladder and inserting the end part 13 of tube 2 into the hollow body of a lower rung 14. This process is repeated with the tubes parts 12 and 13 on the other side of the stabiliser by inserting the tubes 12 and 13 into the other end of the respective rungs such that the two tubes 12 releasably engage with each other and similarly the tubes 13 engage with each other to secure the stabiliser to the ladder. The stabiliser comprises a bracing bracket comprising parts 3a and 3b which have male and female mating parts and which are releasably securable, for example using a push button arrangement (not shown).

FIG. 4 shows a stabiliser which may be used also to ensure the ladder is level. Bracket 5 sits on a moveable plate (not shown) inside track 4 which is fitted with a ratchet and fixing device (not shown) allowing the plate to be moved either away or towards the ladder. As this plate is joined to lower part strut 2, moving it will have the effect of raising or lowering stile 16 or the right hand stile 15 allowing the user to level the ladder. In this diagram bracket 5 and thus stile are at their highest setting so any movement away from the ladder by bracket 5 will lower stile 16. Movable brackets may be employed on either or both struts 2].

A line between the feet 9 and the top of the stile 16 is shown as P-P′ and the axis of stile 16 is shown as A-A′. The ladder (and therefore line A-A′ is at an angle of 75° to the ground. The line P-P′ is at an angle of 60° to the ground and with the corresponding line through stile 15 (not shown) defines a “virtual ladder”. The centre of gravity of a user standing on a stabilised ladder according to the invention relative to a triangle defined by the wall, ground and P-P′ will be closer to that triangle than will be the centre of gravity of a user standing on a conventional ladder at 75° relative to a triangle defined by the wall, ground and a line A-A′. Without wishing to be bound by theory, we believe this may be the basis for a much greater sense of stability for the user when using the present invention.

The point UP denotes the point at which the upper part strut 1 engages with the ladder 16. The point LP denotes the point at which the lower part strut 2 engages with the ladder 16. The point CP denotes the point at which the lower part strut 2 and the upper part strut 1 are connected. The distance from UP to CP is greater than or equal to the distance from UP to LP.

FIG. 5 shows an embodiment of the invention as illustrated in FIG. 4.

FIG. 6 illustrates, without wishing to be bound by any theory, how the invention provides a configuration which avoids or has reduced outward slip. The weight W of a user located on the ladder above point UP causes a pivoting moment about point UP which urges point LP to pivot about UP in the direction of arrow, M, ie anti-clockwise. Relative to point CP, the point LP is urged to pivot in a direction M′ which is in the opposite direction of rotation ie clockwise to the moment at point UP. This moment urges the feet 9 at point P in a direction of rotation towards the wall. Outward slip is thereby reduced or avoided.

Point XP is the same distance from point UP as point LP is from UP. The point CP is suitably further from UP than point XP. If the point CP were closer to the point UP than point LP is to point UP, the moment of rotation about point CP would be in the same direction as the moment of rotation about point UP and the ladder would be susceptible to outward slip in the same manner as a conventional ladder or a notional “bent” ladder which extended from point P′ to UP at which it bent and then towards point P.

FIG. 7 illustrates a ladder stabiliser arrangement not in accordance with the invention which, without wishing to be bound by any theory, may be susceptible to outward slip. The weight W of a user located on the ladder above point UP causes a pivoting moment about point UP which urges point LP to pivot about UP in the direction of arrow M. Point CP is closer to UP than point XP in this illustration. Relative to point CP, the point LP is urged to pivot in a direction M′ which is in the same direction of rotation as the moment at point UP. This moment urges the feet 9 at point P in a direction of rotation away from the wall. Outward slip may therefore occur depending on the frictional force resisting such slip at point P as is the case with a conventional ladder standing on the ground.

What is claimed is:

1. A ladder stabiliser for use with a ladder comprising two stiles positioned against a wall, the ladder stabiliser comprising a body and two or more feet for engagement with a surface wherein the feet are configured such that in use the feet are located on the surface at points which are distant from the point at which the axes of the stiles intersect the surface and is configured such that the weight of the user avoids urging the feet of the stabiliser or stabilised ladder in a direction away from the wall and wherein the stabilizer body comprises an upper part and a lower part which parts, in use, engage with the ladder to support the ladder whereby the two stiles are not in contact with the surface.

2. A ladder stabiliser for use with a ladder comprising two stiles positioned against a wall, the ladder stabiliser comprising a body and two or more feet for engagement with a surface wherein the feet are configured such that in use a line between the feet and the top of the ladder stiles is at an angle of about 55 to 65° to the ground and the ladder is at an angle of 70 to 80° to the ground and wherein the stabilizer body comprises an upper part and a lower part and is configured such that the weight of the user causes the adder to be braced between the lower part and the upper part and avoids urging the feet of the stabiliser or stabilised ladder in a direction away from the wall.

3. (canceled)

4. The ladder stabilizer of claim 1 wherein the upper part and lower part are connected at a point CP such that the distance from the point at which the upper part engages the ladder to the point CP is greater than or equal to the distance from the point at which the lower part engages the ladder to the point CP.

5. (canceled)

6. The ladder stabilizer of claim 1 wherein the upper part and lower part are movable relative to each other at the point at which the upper and lower part are connected.

7. The ladder stabilizer of claim 6 wherein the upper part is slideably movable relative to the lower part.

8. The ladder stabilizer of claim 7 wherein the upper part is connected to the lower part by a bracket and the bracket comprises a track attached to either the upper or the lower part such that the other part is held within the track and slidably moveable along the track relative to the other part.

9. The ladder stabilizer of claim 1 wherein the upper and lower parts comprise tubular struts.

10. The ladder stabilizer of claim 1 wherein the body comprises a rigid body with which a rung of the ladder is engagable.

11. (canceled)

12. The ladder stabilizer of claim 1 comprising a securing mechanism for releasably securing the stabiliser to the ladder that is manually operable without tools.

13. The ladder stabilizer of claim 9 wherein the securing mechanism comprises a bracing bracket which is adapted to engage the back of the ladder relative to the position of the stabiliser thereby securing the stabiliser and ladder together and optionally said bracing bracket comprising male and female parts interengageable with each other.

14. The ladder stabilizer of claim 12 for use with a ladder having hollow rungs wherein the securing mechanism comprises male and female parts interengageable with each other through a hollow rung of the ladder.

15. The ladder stabilizer of claim 1 wherein the securing mechanism comprises two pairs of male and female parts with each male and female pair being interengageable through a hollow rung of the ladder.

16. The ladder stabilizer of claim 1 wherein the feet are made of rubber or a plastics material and optionally have a frictional surface pattern.

17. The ladder stabilizer of claim 1 wherein each foot is connected to the body of the stabiliser via a universal joint.

18. The ladder stabilizer of claim 1 wherein each foot is connected to the body of the stabiliser via a part which may be arranged in a first configuration such that the feet are engagable with the ground and a second configuration whereby the feet are 180° from the first configuration whereby the stabiliser may be employed at the top of a ladder for engaged with a surface at the top of the ladder.

19. A kit of parts for assembly into a stabilised ladder comprising:
i) a stabiliser according to claim 1; and
ii) a ladder.

20. A stabilised ladder comprising a stabiliser according to claim 1 integral with a ladder.

21. The stabilised ladder of claim 20 wherein the stabiliser supports the ladder at an angle of 70 to 80° to the ground and the angle between a line through the feet of the stabiliser and the top of the ladder stiles to the ground is 55 to 65°.

22. (canceled)

23. (canceled)

24. The stabilised ladder of claim 20 wherein, in use, the ladder is floating above the ground.

25. (canceled)
